(19) United States
(12) Patent Application Publication
(10) Pub. No.: US 2012/0226565 A1
(43) Pub. Date: Sep. 6, 2012

(54) Method and apparatus for payment with mobile device at point of sale terminal

(75) Inventor: Youriy Drozd, Fremont, CA (US)

(73) Assignee: MOTREUS INC., Fremont, CA (US)

(21) Appl. No.: 13/041,374

(22) Filed: Mar. 5, 2011

(51) Int. Cl. G06Q 20/00

(52) U.S. Cl. 705/16

(57) ABSTRACT

A method and apparatus for payment with mobile device at point of sale (POS) terminal are proposed, where said apparatus is comprised of a microprocessor which connects to POS terminal as a payment console and communicates with said POS terminal via protocols developed for payment consoles; said apparatus also has an additional connection to internet via which the apparatus communicates with services supporting its function. The mobile device operated by a user captures a public token exposed by said POS terminal and communicates with the supporting internet services, which validate said mobile device, authenticate the mobile device owner, validate the POS terminal, and establish link between said mobile device and said apparatus. As said link is established, in response to the payment request sent by said POS terminal to said apparatus, said apparatus communicates payment details with said mobile device, said user authorizes the payment on said mobile device, and the transaction gets executed by a money processor as with regular payment console.

### CROSS REFERENCE TO RELATED APPLICATIONS

none

### DESCRIPTION

### Background

The present invention relates to payment transactions in retail stores facilitated by wireless internet-enabled mobile devices.

There are trends in consumer electronics to connect every electronic device with a network via wireless communication channel and to combine functionality of several devices in one. The most notable result of these efforts is smartphone, which combines powerful computer, mobile phone, internet hub, digital camera, music player and personal digital assistant in one body. The present application is related mainly to smartphones, though most of other internet-enabled mobile devices, which include but not limited to personal digital assistants, digital music players, digital cameras, and ultra-portable notebooks, may perform the described tasks. In patent claims, therefore, we use a term “mobile station” to cover all described cases.

Smartphones are inherently personal devices as they are linked with phone numbers at which their owners can be reached. The owners usually hold the phones at arm length at all times and reluctantly, if ever, share them with other people. Smartphones are also frequently protected from unauthorized access by a personal identification number (PIN) code. In security-related context a term “personal trusted device” (PTD) was coined to underscore the fact that the owner of a device delegates his/her identity to such a device.

Given the identity delegation described, a natural step would be to perform different kinds of transactions with smartphones on the behalf of their owners. As significant effort has been made in this direction, the major problems became clearer. The present application addresses two of these problems.

The first problem is related to establishing a link between a point of sale terminal and a mobile station. Two major solutions are proposed: optical, with 1D and 2D barcodes, and using radio frequency, near-field communication devices (NFC) and radio-frequency identification (RFID) chips. All currently available solutions for both optical and radio frequency cases require a point of sale terminal to be equipped with a reader to capture a signal from mobile station. It can be an optical barcode reader to capture a code displayed on the smartphone screen, as in Starbucks, or a RFID reader to identify an RFID tag attached to a mobile phone, as with Bling Nation. Need for such a reader creates a major obstacle for quick and wide adoption of mobile payments since it requires substantial investments.

The second problem is related to integrating of a mobile payment solution with POS terminals. Whenever new devices such as optical reader or NFC device are connected to a POS system, it requires a substantial change in the POS software. This challenging task, given large number of POS manufacturers and general reluctance of merchants to modify POS software, creates a serious obstacle for the mobile payment adoption.

### SUMMARY OF THE INVENTION

In order to resolve aforementioned problems and to facilitate adoption of mobile payments, a new apparatus and new method for seamless integration of mobile payments with existing POS terminals is proposed.

The apparatus is comprised of a microprocessor with non-volatile memory that stores a unique device identification number, volatile memory to support computations, and two gateways: one for connecting the apparatus to POS terminal and the other for wired or wireless connecting to internet. Through the former gateway the apparatus poses itself to POS terminal as a standard payment console used for accepting debit and credit cards and uses standard communication protocols for payment consoles. The second gateway is used for communicating an identity service that establishes handshake between the mobile station and the POS terminal, and validates identities of the mobile station, its owner and the POS terminal. This gateway is also used for communicating with money processor similarly to payment consoles. As a result, POS terminal engages into mobile payment transactions treating the attached apparatus as a standard payment console, which does not require any changes in POS terminal software.

The method is also provided for transmitting an identity token from POS terminal to a mobile station with subsequent establishing a handshake, device and used verification, and negotiations between the parties involved to complete a transaction that appear to the POS terminal as coming from a standard payment console.

### BRIEF DESCRIPTION OF THE DRAWINGS

FIG. 1. Apparatus with serial and Ethernet connectors.

FIG. 2. Apparatus, protocols, and environment.

FIG. 3. Communication diagram for ACH payment with smartphone in a store.

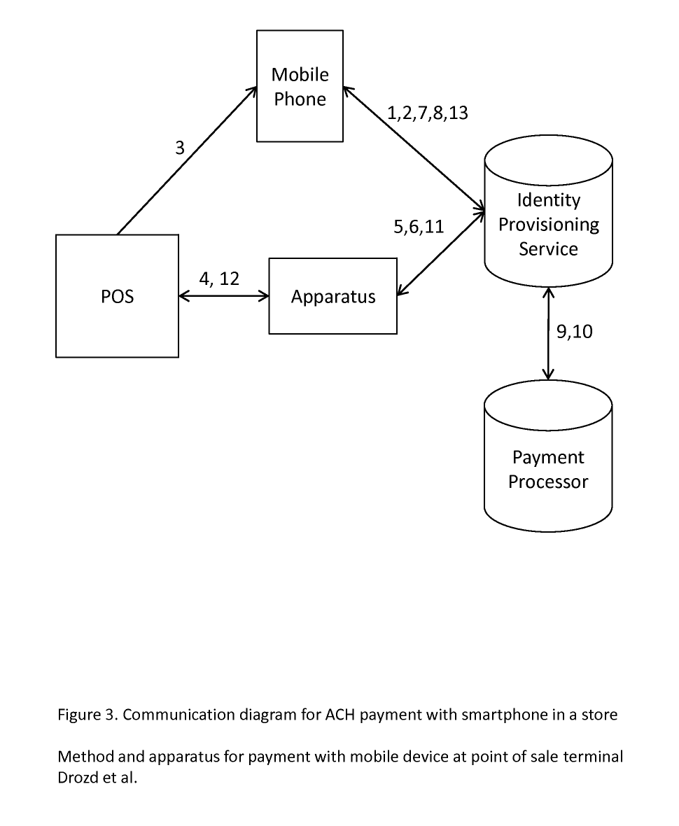

### DETAILED DESCRIPTION OF THE PREFERRED EMBODIMENTS

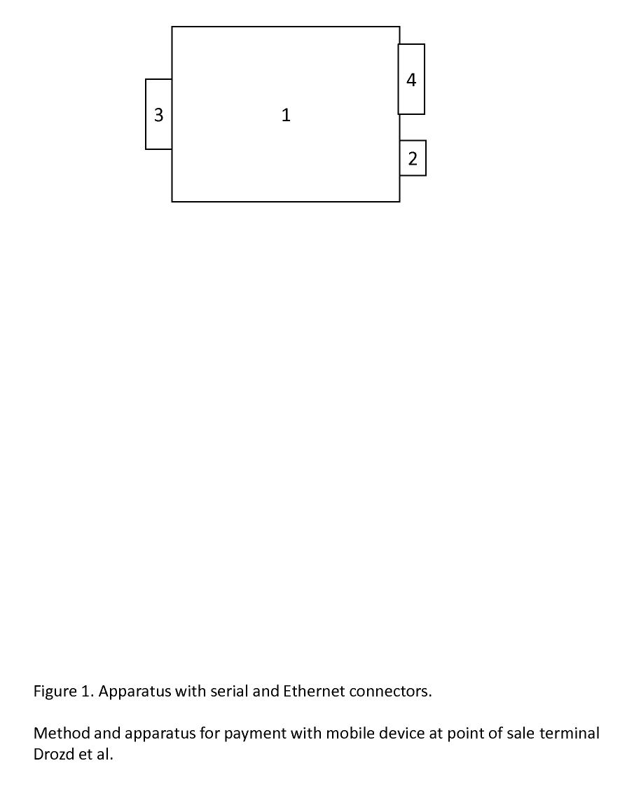

In FIG. 1, the apparatus consists of a plastic enclosure 1 containing a programmable microprocessor and an electronic circuit supporting the microprocessor operation. A power socket 2 is used for connecting a low-voltage power adapter to the apparatus. A serial port 3 is a standard RS232C port used for connecting by cable the apparatus with a POS terminal. An Ethernet socket 4 is used to connect with a cable the apparatus and external internet services.

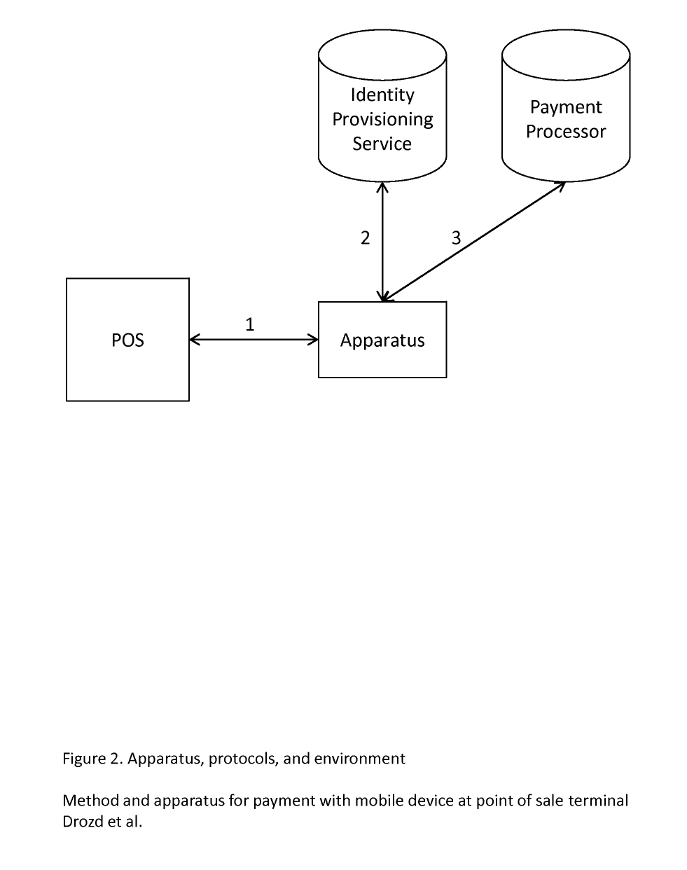

In FIG. 2, the apparatus is connected with POS terminal with RS232C channel 1. The apparatus supports standard protocols for POS terminals, including but not limited to VISA1, VISA2, and ISO8583. The choice of a specific protocol to be used gets settled during the handshake between the apparatus and the POS terminal.

The apparatus is connected via internet channel 2 with identity provisioning service using encrypted TCP/IP messages. The apparatus is connected via internet channel 3 with a payment processor service also using encrypted TCP/IP messages.

In present embodiment a customer visits a supermarket, collects desired items in a shopping cart, and approaches a checkout counter to check out. A clerk starts checking the merchandize from the cart with POS terminal. At the same time the customer picks up his/her smartphone with embedded camera and payment app installed. The customer starts the app, enters the PIN, the app sends (arrow 1) the smartphone and customer credentials to the identity provisioning server (IPS), the server sends confirmation to the smartphone (arrow 2), and the app is ready for payment routine. The customer scans with the phone camera a 2-dimensional barcode displayed at the POS. This code uniquely identifies this POS terminal. The phone decodes a unique number, encoded in the scanned code, and sends this number to IPS (arrow 3). With this number IPS establishes a link between the customer and the POS terminal is established.

The session is maintained till the clerk at POS finishes checking the customer items, gets a total price, and initiates payment. The POS sends to the apparatus the total price (arrow 4) and starts communicating with the apparatus as if it is a payment console with a card reader and a pin pad. The apparatus, instead of interacting with the customer and a payment processor, as a payment console would, sends requests to IPS over internet (arrow 5) and receives the status updates from IPS (arrow 6). During this exchange IPS contacts the customer (arrow 7) through the app asking to confirm the total amount. After the total is confirmed (arrow 8), IPS retrieves the customer bank routing number and account number from its database and sends an ACH transaction request to the payment processor (arrow 9). The processor processes the request and sends a message to IPS about completion of the transaction (arrow 10). IPS relays this message to the apparatus (arrow 11), which, in turn, relays it to the POS (arrow 12). The POS displays a message that transaction was completed, and the POS is now ready to process next customer. IPS also sends to the customer smartphone a digital receipt of the transaction (arrow 13).

This concludes an ACH transaction in a store over mobile phone.

1. (canceled)

2. (canceled)

3. (canceled)

4. (canceled)

5. A system for a wireless payment transaction with a mobile station at a Point Of Sale (POS) terminal comprising:
a POS terminal comprising hardware having a communications port and software supporting POS protocols;
a microprocessor-enabled hardware enclosure comprising a microprocessor, one port for communication with said POS terminal hardware, and a second port for communication with the internet;
said microprocessor-enabled hardware enclosure physically separate from said POS terminal hardware, said POS terminal receiving data and transmitting data to and from the microprocessor-enabled hardware enclosure;
a mobile station for only receiving data from the POS terminal hardware;
a server comprising an Identity Provisioning Server (IPS) for identifying said POS terminal hardware and said mobile station, said IPS receiving direct communications from said mobile station and said microprocessor-enabled hardware enclosure;
wherein said microprocessor-enabled hardware enclosure and mobile station are not in direct communication with one another;
wherein said IPS and POS terminal are not in direct communications with one another; and,
wherein said mobile station and said microprocessor-enabled hardware enclosure cooperate with said POS terminal and said IPS to complete a wireless payment transaction, and, wherein said POS terminal hardware communicates with said microprocessor-enabled hardware enclosure as if said microprocessor-enabled hardware enclosure was a payment console.

6. The invention according to claim 5, wherein:
said mobile station comprises an internet-enabled mobile device selected from the group consisting of smartphones, personal digital assistants, digital music players, digital cameras, and ultra-portable notebooks;
said POS terminal has a code associated with it to uniquely identify said POS terminal hardware, and said POS terminal code comprises a short range one-directional signaling from said POS terminal transmitting a unique identification number of said POS terminal, said internet-enabled mobile device communicating said short range one-directional signaling to said IPS.

7. The invention according to claim 5, wherein:
said mobile station having a unique device identifier to identify said mobile station.

8. The invention according to claim 7, wherein:
said microprocessor-enabled hardware enclosure apparatus is associated with a unique identification number;
said POS terminal has a code associated with it to uniquely identify said POS terminal hardware, and said mobile station identifies said POS terminal hardware with said POS terminal code, and,
said mobile station communicating said POS terminal code to said IPS.

9. The invention according to claim 7, wherein:
said microprocessor-enabled hardware enclosure apparatus is associated with a unique identification number;
said mobile station comprises an internet-enabled mobile device selected from the group consisting of smartphones, personal digital assistants, digital music players, digital cameras, and ultra-portable notebooks.

10. The invention according to claim 7, wherein:
said microprocessor-enabled hardware enclosure apparatus is associated with a unique identification number.

11. The invention according to claim 10, wherein:
said microprocessor-enabled hardware enclosure second port sends data received from said POS terminal to said IPS through said second port.

12. The invention according to claim 11, wherein:
a payment processor connected to said IPS, said payment processor for processing data from said IPS relating to said wireless payment transaction;
said POS terminal sending said microprocessor-enabled hardware enclosure data comprising a total price;
said IPS sends data relating to said wireless payment transaction to said payment processor and said IPS sending data to said mobile station comprising a total price amount, said payment processor sending completion data comprising completion of the wireless payment transaction to said IPS, said IPS relaying said completion data to said microprocessor-enabled hardware enclosure, and said microprocessor-enabled hardware enclosure relaying said completion data to said POS terminal hardware.

13. The invention according to claim 12, wherein:
said microprocessor-enabled hardware enclosure port of communication with said POS terminal hardware is a serial port.

14. The invention according to claim 13, wherein:
said microprocessor-enabled hardware enclosure second port is an Ethernet port, and said serial port is a standard RS232C port.

15. The invention according to claim 14, wherein:
said microprocessor-enabled hardware enclosure supports standard protocols for POS terminals comprising the protocols selected from the group consisting of VISA1, VISA2 and ISO8583.

16. The invention according to claim 15, wherein:
said microprocessor-enabled hardware and said POS terminal communicating with one another during a handshake to determine which standard protocol of said standard protocols to employ.

17. The invention according to claim 7, further comprising:
a payment processor connected to said IPS, said payment processor for processing data from said IPS relating to said wireless payment transaction.

18. The invention according to claim 17, further comprising:
a database for storing data comprising customer bank routing numbers and account numbers associated with customers making wireless payment transactions;
said IPS retrieves said data from said database.
said IPS sends data relating to said wireless payment transaction to said payment processor and said IPS sending data to said mobile station comprising a total price amount, said payment processor sending completion data comprising completion of the wireless payment transaction to said IPS, said IPS relaying said completion data to said microprocessor-enabled hardware enclosure, and said microprocessor-enabled hardware enclosure relaying said completion data to said POS terminal hardware.

19. The invention according to claim 7, wherein:
said mobile station comprises a camera, said POS terminal has a code associated with it to uniquely identify said POS terminal hardware, and said POS terminal code comprises a barcode, said mobile station communicating said barcode to said IPS by scanning said barcode with said camera.

20. The invention according to claim 19, further comprising:
a database for storing data comprising customer bank routing numbers and account numbers associated with customers making wireless payment transactions.
